(19) United States
(12) Patent Application Publication
(10) Pub. No.: US 2018/0229897 A1
(43) Pub. Date: Aug. 16, 2018

(54) CONTAINER BAG WITH MULTIPLE SEALABLE LOCKS

(71) Applicant: Bassam Abed, Bakersfield, CA (US)

(72) Inventor: Bassam Abed, Bakersfield, CA (US)

(21) Appl. No.: 15/954,409

(22) Filed: Apr. 16, 2018

Related U.S. Application Data
(62) Division of application No. 15/299,430, filed on Oct. 20, 2016.
Application No. 15/299,430 is a continuation-in-part of application No. 12/660,598, filed on Mar. 1, 2010.
Application No. 12/660,598 is a continuation-in-part of application No. 12/315,796, filed on Dec. 5, 2008, now abandoned.

(51) Int. Cl. B65D 33/25; B31B 70/00; B65D 77/08; B65D 75/52; B31B 70/81; B65D 81/32; B31B 170/00; B31B 160/10; B31B 155/00

(52) U.S. Cl. CPC B65D 33/2591; B31B 70/00; B65D 77/08; B65D 75/527; B31B 2155/002; B65D 81/3266; B31B 2170/00; B31B 2160/10; B31B 70/8131; B31B 70/81

(57) ABSTRACT

A container body includes a bag body and a resealable lock. The bag body includes first and second layers overlapped with each other, wherein the bag body further has a plurality of sealing portions provided thereat to form first and second sealing pockets discretely provided between the first and second layers, wherein three of the sealing portions are provided at three sealing edges of the first sealing pocket and three of the sealing portions are provided at three sealing edges of the second sealing pocket, such that each of the first sealing pocket and the second sealing pocket has an unsealed edge serving as an elongated opening. The resealable lock includes a plurality of zip lockers provided at the elongated openings of the first and second sealing pockets, wherein each of the first and second sealing pockets is reclosably sealed by the resealable lock.

### CROSS REFERENCE OF RELATED APPLICATIONS

This is a Divisional application of the Continuation-In-Part application Ser. No. 15/299,430 filed Oct. 20, 2016 that claims priority to U.S. non-provisional application, application Ser. No. 12/660,598, filed Mar. 1, 2010, which is a Continuation-In-Part application that claims priority to U.S. non-provisional application, application Ser. No. 12/315,796, filed Dec. 5, 2008, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a container bag, and more particularly to a container bag with multiple sealable locks, wherein the container bag has a plurality of discrete sealing pockets adapted for individually packing different objects in an air-tight manner.

### Description of Related Arts

A container bag usually made of a non-rigid, semi-rigid, or flexible material is used for packing or carrying items such as frozen food, fresh produce, snack foods etc. Most of the bags are heat sealed together. A press-to-close zipper or sliding zipper is used to close and open the bag in a resealable manner, and to seal the items in the bags to keep the items fresh or prevent leaking.

There are many different bags in the market for different purposes. Take a food bag for example, a food bag is used for transporting food for picnicking, wherein a sandwich and fruits are packed in one bag. However, the sandwich may get wet or soaked by the fruits. Therefore, most people would like to separate the sandwich and the fruits into different food bags. Packing the sandwich with the snacks, as another example, a person may put the sandwich and snacks in one bag for convenience or utilizing the usage of the bag, so that the flavor may be mixed and destroyed the taste of the original food. It is worth mentioning that the food bag has a standard size that it is a waste for the food bag to store a small amount of food, such as the snacks.

For solving those problems, a bag having different pockets is provided for separating the different foods in one bag so as to utilize the space of the bag. Though this type of bag solved the mixing different foods problems, the shared opening makes no choose but opening all the pockets at the same time. It is not only inconvenient but also hard to keep it fresh when the single shared opening is opened for all the pockets.

In order to separate the different foods, a container bag for segregating the different foods in one container bag is also provided. The bag has more than two compartments for housing the different foods such as two liquid foods. However, the separated compartments are permanently sealed. It's impossible to reuse the bag or re-close the bag after the bag is unsealedly opened.

Another problem of this container bag is the inconveniency of mixing the separated food being stored in different compartments of the container bag. Take the salad meal as example. The vegetables may be stored in one of the compartment while the salad dressing may be stored in another compartment of the container bag for optimizing the freshness of the salad. When the user is able to enjoy the salad, the salad dressing and the vegetable separately contained in the same container bag are difficult to mix together for forming the salad meal.

Sometimes, a set of separated containers need to be grouped together. They are either contained by a bigger container which costs extra, or are bundled together which is still not convenient and reliable.

Furthermore, the size of the opening of the container bag may be limited by the container bag original shape, so that the opening may not have a length long enough for accessing the receiving cavity of the container bag to accommodate the object through the opening. In other words, the receiving cavity may only be able to receive the object having a volume less than the receiving cavity due to the limited size of the opening.

### SUMMARY OF THE PRESENT INVENTION

An object of the present invention is to provide a container bag with multiple sealable locks, wherein the length of the sealing opening is increased for conveniently accessing the sealing pocket therethrough.

Another object of the present invention is to provide a method of preparing a meal by the container bag, so that two or more different types of food are able to be individually stored and conveniently mixed for forming the meal when a user is about to consume thereof.

Another object of the present invention is to provide a container bag with multiple sealable locks, wherein at least one of the sealing openings of the sealing pocket is inclined to increase the length thereof.

Another object of the present invention is to provide a container bag with multiple sealable locks, wherein at least one of the sealing openings is curved to increase the length thereof.

Another object of the present invention is to provide a container bag with multiple sealable locks, wherein at least one of the sealing openings is inclined and curved to increase the length thereof.

Another object of the present invention is to provide a container bag with multiple sealable locks, wherein the container bag has a plurality of discrete sealing pockets adapted for individually packing different objects in an air-tight manner.

Another object of the present invention is to provide a container bag with multiple sealable locks, wherein each of the sealing pockets has its own sealable lock such that when one of the sealing pockets is opened, other sealing pockets are remained unsealed.

Another object of the present invention is to provide a container bag with multiple sealable locks, wherein the sealable lock can reusable to permit each of the sealing pockets being reclosably sealed in a reusable manner.

Another object of the present invention is to provide a container bag with multiple sealable locks, wherein the container bag can separate different foods in one bag for the convenience of a person to carry and transport the food so as to utilize the space the container bag.

Another object of the present invention is to provide a container bag with multiple sealable locks, wherein the container bag has a plurality of discrete sealing pockets adapted for individually packing different objects in an air-tight manner and selectively rearranging the combination-configuration of the container bag.

Another object of the present invention is to provide a container bag with multiple sealable locks, which is easy to combine and separate the discrete sealing pockets via a detachable fastening arrangement.

Another object of the present invention is to provide a container bag with multiple sealable locks, wherein the sealing pockets can be normally used when each of the sealing pockets is fastened to or detached from another sealing pocket so as to enhance the practice use of the container bag.

Another object of the present invention is to provide a container bag with multiple sealable locks, which does not require to alter the original structural design of the container bag, so as to minimize the manufacturing cost of the container bag incorporating with the sealable locks.

Another object of the present invention is to provide a container bag with multiple sealable locks, wherein no expensive or complicated structure is required to employ in the present invention in order to achieve the above mentioned objects. Therefore, the present invention successfully provides an economic and efficient solution for providing a container body with multiple sealing pockets and multiple sealable locks to individually access the sealing pockets.

Accordingly, in order to accomplish the above objects, a container bag of the present invention comprises a bag body and a resealable lock.

The bag body comprises a first layer and a second layer overlapped therewith, and defines a plurality of sealing pockets discretely provided between the first and second layers and a plurality of elongated sealing openings communicating with said sealing pockets respectively.

The resealable lock comprises a plurality of zip lockers provided at the sealing openings respectively to seal and enclose the sealing pockets, wherein each of the zip lockers is individually actuated to unsealed and open the sealing pocket so as to permit each of the sealing pockets being reclosably sealed in a reusable manner.

Accordingly, in order to accomplish the above objects, the present invention also provides a container bag, which comprises a bag body comprising the first and second layer overlapping therewith and defining at least two sealing pockets discretely provided between the first and second layer.

Each of the sealing pockets has an elongated sealing opening for communicating with each of the sealing pockets, wherein at least one of the sealing openings of the sealing pocket is inclined to extend non-parallely to another sealing opening to increase a length of the inclined sealing opening.

The container bag further has a resealable lock which comprises a plurality of zip lockers provided at the sealing openings respectively to seal and enclose the sealing pockets, so as to permit each of the sealing pockets being reclosably sealed in a resealable manner.

A method of preparing a meal by the container bag is further provided, wherein the method comprises the following steps.

(a) Fill a first type food in a first sealing pocket of the container bag.

(b) Fill a second type food in a second sealing pocket of the container bag adjacent to the first sealing pocket 13.

(c) Tear the tearing line at the sealing portion between the first and second sealing pocket for tearing apart the first and second sealing pocket.

(d) Resealably unseal the first and second sealing pocket.

(e) Pull the second type food within the second sealing pocket into the first sealing pocket for mixing with the first type food therewithin.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a container bag according to a first preferred embodiment of the present invention.

FIG. 2 is a sectional view of the container bag according to the first preferred embodiment of the present invention.

FIG. 3 is a perspective view of a container bag according to a second preferred embodiment of the present invention.

FIG. 4 is a sectional view of the container bag according to the second preferred embodiment of the present invention.

FIGS. 5A to 5C illustrate the alternative modes of the container bag according to the first and second preferred embodiments of the present invention.

FIG. 6 is a schematic view illustrating a manufacturing process the container bag according to the preferred embodiment of the present invention.

FIG. 7 is a perspective view of a container bag according to a third preferred embodiment of the present invention.

FIG. 8 is a sectional view of the container bag according to the above third preferred embodiment of the present invention.

FIGS. 9A to 9C illustrate the alternative modes of the container bag according to the above third preferred embodiments of the present invention, illustrating the combination-configurations of the bag body.

FIGS. 10A to 10C illustrate the alternative modes of the detachable fastening arrangement of the container bag according to the above third preferred embodiment of the present invention.

FIG. 11 is a perspective view of the container bag according to the above third preferred embodiment of the present invention, illustrating the sealing pockets being integrally attached edge-to-edge.

FIG. 12 is a perspective view of the container bag according to a fourth preferred embodiment of the present invention, illustrating a first example of the fourth embodiment.

FIG. 13 is a perspective view of the container bag according to the fourth preferred embodiment of the present invention, illustrating a second example of the fourth embodiment.

FIG. 14 is a perspective view of an alternative container bag according to the fourth preferred embodiment of the present invention.

FIGS. 15A and 15B illustrate an alternative mode of the container bag according to the above embodiments of the present invention.

FIGS. 16A and 16B illustrate another alternative mode of the container bag according to the above embodiments of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

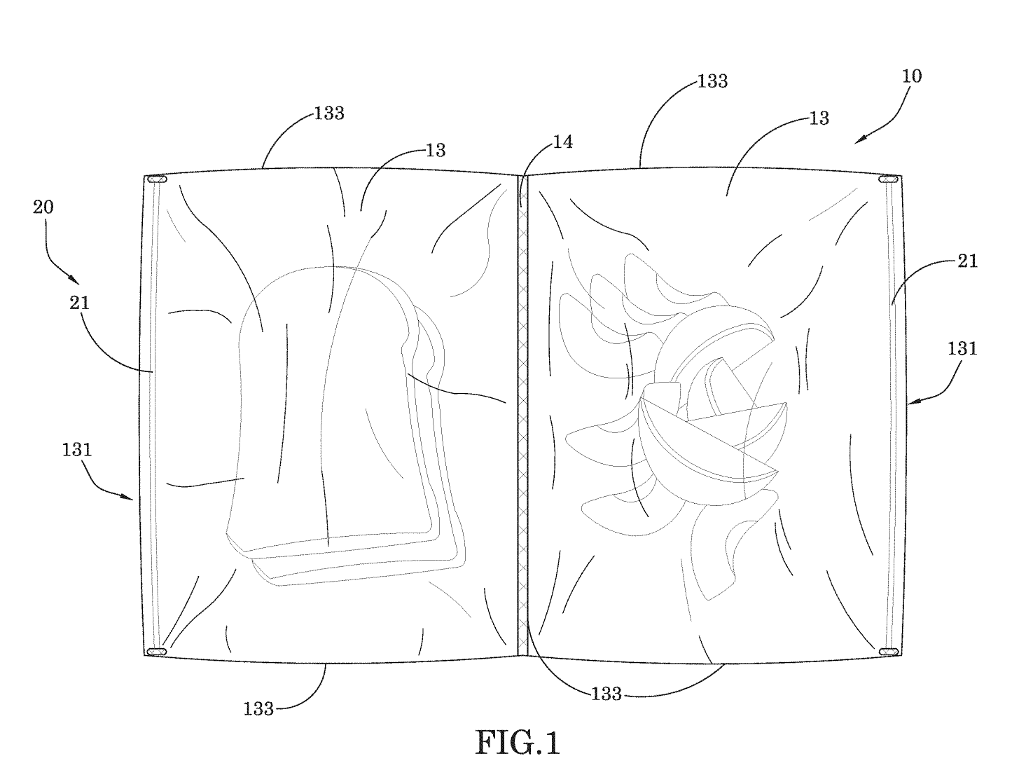

Referring to FIG. 1 of the drawings, a container bag of the present invention is illustrated, wherein the container bag, which is adapted for storing different items in a separated air-tight manner, comprises a bag body 10 and a resealable lock 20.

The bag body 10 comprises a first layer 11 and a second layer 12 overlapped therewith, and defines a plurality of sealing pockets 13 discretely provided between the first layer 11 and the second layer 12 and a plurality of elongated sealing openings 131 for communicating with the sealing pockets 13 respectively.

The resealable lock 20 comprises a plurality of zip lockers 21 provided at the sealing openings 131 respectively to seal and enclose the sealing pockets 13, wherein each of the zip lockers 21 is individually actuated to unsealed and open the sealing pocket 13 so as to permit each of the sealing pockets 13 being reclosably sealed in a reusable manner.

According to the preferred embodiment, the first and second layers 11, 12 are made of flexible material and preferably have good oxygen barrier properties to keep the items, especially for edible products, within the sealing pockets 13. As shown in FIG. 1, two sealing pockets 13 are provided within the first and second layers 11, 12, wherein the two sealing pockets 13 are identical and each of the sealing pockets 13 is formed between half of the first layer 11 and corresponding half of the second layer 12.

In addition, the bag body 10 further has one or more sealing portions 14 that the first layer 11 is permanently sealed with the second layer 12 to form a partition between the two neighboring sealing pockets 13. As shown in FIG. 1, the sealing portion 14 is formed along a centerline of the bag body 10 to permanently seal the first and second layers 11, 12 with each other such that the centerline of the bag body 10 form the partition to separate the two sealing pockets 13. In other words, two different items, such as sandwich and snacks, can be stored in the sealing pockets 13 respectively.

Accordingly, each of the sealing openings 131 is a discrete opening formed at the bag body 10 that each of the sealing pockets 13 has an air-tight chamber 132 when the sealing opening 131 is sealed via the respective zip locker 21, in such a manner that the air-tight chamber 132 of each of the sealing pockets 13 is inaccessible to another the air-tight chamber 132 of the neighboring sealing pocket 13. In other words, the user is able to take out the item within the corresponding sealing pocket 13 via the respective zip locker 21 while the item within another sealing pocket 13 is remained sealed.

Preferably, each of the sealing pockets 13, which is formed in a rectangular shape, has three sealing edges 133 and a sealable edge to define the sealing opening 131 therealong. In other words, the three sealing edges 133 of each of the sealing pockets 13 are permanently sealed while the zip locker 21 is provided at the sealable edge of the sealing pocket 13. Accordingly, at least one of the sealing openings 131 is formed along a peripheral edge of the bag body 10.

The two air-tight chambers 132 of the sealing pockets 13 are formed to prevent the food from leaking so as to prevent the foods from mixing in different sealing pockets 13. In order words, two of the sealing pockets 13 are sharing one of the sealing edges as a common edge along the sealing portion 14 which is the partition for separating the two sealing pockets 13 to form two air-tight chambers 132 for sealing the foods in different sealing pockets 13.

In particularly, the sealing opening 131 of one of the sealing pockets 13 is formed along one side peripheral edge of the bag body 13 while the sealing opening 131 of another sealing pocket 13 is formed along another side peripheral edge of the bag body 13, as shown in FIG. 1. Therefore, at least two of the sealing openings 131 are provided at the bag body 10 and are extended in a parallel manner.

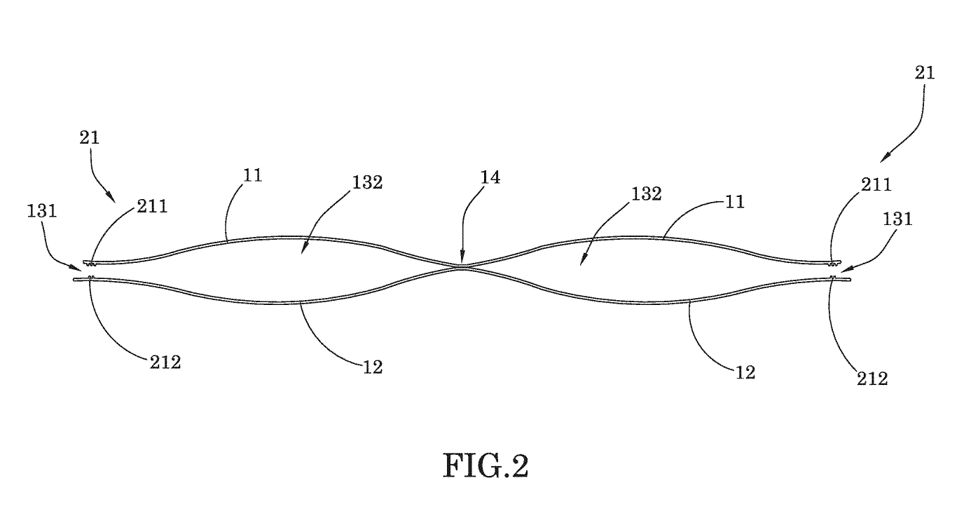

As shown in FIG. 2, each of the zipper lockers 21 comprises a first zipper 211 integrally provided along an opening edge of each of the sealing openings 131 at the first layer 11 and a second zipper 212 integrally provided along an opening edge of the respective sealing opening 131 at the second layer 12 to detachably engage with the first zipper 211 so as to seal and enclose the respective sealing pocket 13. Accordingly, the two opening edges of each of the sealing opening 131 are detachably engaged with each other via the first and second zippers 211, 212 to seal and enclose the respective sealing pocket 13.

According to the preferred embodiment, the first and second zippers 211, 212 are zipper-type-reclosable fasteners integrally provided at the first and second layers 11, 12 respectively along the sealing opening 131 thereof, wherein the user is able to join the first and second zippers 211, 212 together through the zipper closure action as the user applies thumb and finger pressure in a sweeping motion across the first and second zippers 211, 212 at the sealing opening 131. Once the first and second zippers 211, 212 are engaged with each other, the air-tight chamber 132 is formed within the sealing pocket 13 to seal and enclose the item therein in an air-tight manner. The user is able to unseal and open the sealing pocket 13 by applying an opposite pulling force at the first and second layers 11, 12 to disengage the first zipper 211 with the second zipper 212.

It is worth to mention that the discrete sealing pockets 13 has the discrete sealing opening 131 having the respective zip locker 21 provided thereat, wherein each of the sealing pockets 13 is able to be enclosed and opened individually by press-to-close or pull-to-open the zip locker 21. Therefore, the individual zip lockers 21 provided at the individual sealing openings 131 for each sealing pocket 13 to enable the user to enclose and open the container bag in a reusable manner and to enable the sealing pockets 13 being enclosed or opened individually to avoid the unnecessary opening of the sealing pockets 13 which is not desired to reach. It is appreciated that when the zip locker 21 is closed, the three sealing edges and the sealable edge having the zip locker 21 provided at the sealing opening 131 are formed the air-tight chamber 132 to securely seal the foods into the respective sealing pocket 13.

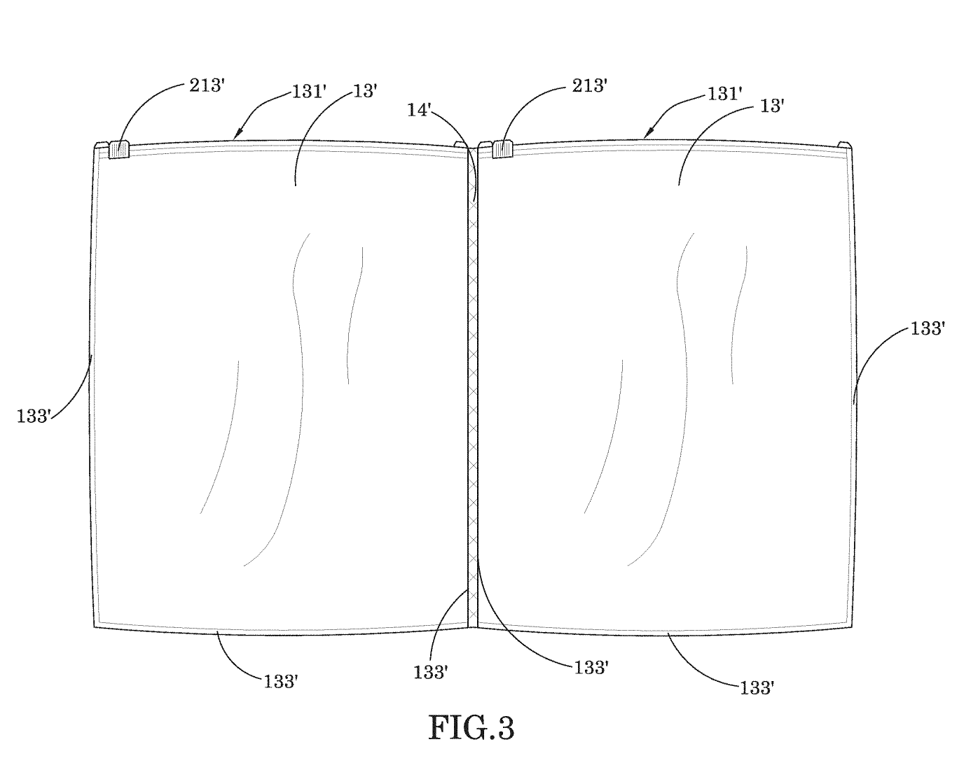

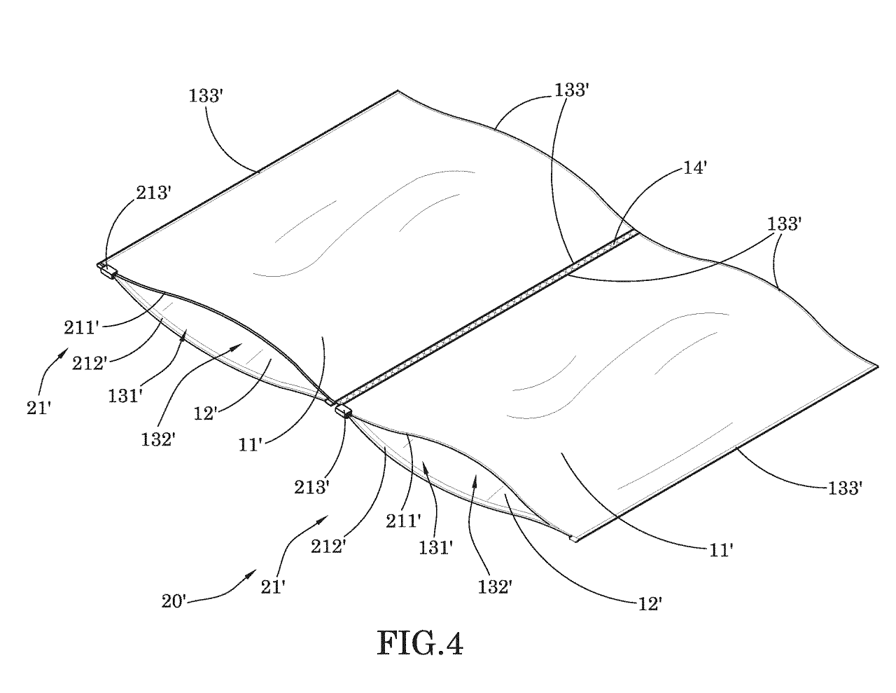

Referring to FIGS. 3 and 4 of the drawings, the container bag of a second embodiment illustrates an alternative mode of the first embodiment, wherein the container bag comprises a bag body 10′ and a resealable lock 20′.

Having the similar structure of the first embodiment, the bag body 10′ comprises a first layer 11′ and a second layer 12′ overlapped therewith, and defines a plurality of sealing pockets 13′ discretely provided between the first layer 11′ and the second layer 12′ and a plurality of elongated sealing openings 131′ for communicating with the sealing pockets 13′ respectively.

The resealable lock 20′ comprises a plurality of zip lockers 21′ provided at the sealing openings 131 respectively to seal and enclose the sealing pockets 13′, wherein each of the zip lockers 21′ is individually actuated to unsealed and open the sealing pocket 13′ so as to permit each of the sealing pockets 13′ being reclosably sealed in a reusable manner.

The bag body 10′ further has one or more sealing portions 14′ that the first layer 11′ is permanently sealed with the second layer 12′ to form a partition between the two neighboring sealing pockets 13′. As shown in FIG. 3, the sealing portion 14′ is formed along a centerline of the bag body 10′ to permanently seal the first and second layers 11′, 12′ with each other such that the centerline of the bag body 10′ form the partition to separate the two sealing pockets 13′. Each of the sealing openings 131′ is a discrete opening formed at the bag body 10′ that each of the sealing pockets 13′ has an air-tight chamber 132′ when the sealing opening 131′ is sealed via the respective zip locker 21′, in such a manner that the air-tight chamber 132′ of each of the sealing pockets 13 is inaccessible to another the air-tight chamber 132′ of the neighboring sealing pocket 13′.

Each of the sealing pockets 13′, which is formed in a rectangular shape, has three sealing edges 133′ and a sealable edge to define the sealing opening 131′ therealong. In other words, the three sealing edges 133′ of each of the sealing pockets 13′ are permanently sealed while the zip locker 21′ is provided at the sealable edge of the sealing pocket 13′. Accordingly, at least one of the sealing openings 131′ is formed along a peripheral edge of the bag body 10′.

As shown in FIGS. 3 and 4, the sealing opening 131′ of one of the sealing pockets 13 is formed along a top peripheral edge of the bag body 13′ while the sealing opening 131′ of another sealing pocket 13′ is formed along the same top peripheral edge of the bag body 13′. In other words, the sealing portion 14′ of the bag body 10′ is provided between two inner ends of the sealing openings 131′ of the sealing packets 13′, such that the sealing portion 14′ forms the partition between the two sealing openings 131′.

As shown in FIGS. 3 and 4, each of the zipper lockers 21′ comprises a first zipper 211′ integrally provided along an opening edge of each of the sealing openings 131′ at the first layer 11′ and a second zipper 212′ integrally provided along an opening edge of the respective sealing opening 131′ at the second layer 12′ to detachably engage with the first zipper 211′ so as to seal and enclose the respective sealing pocket 13′. Accordingly, the two opening edges of each of the sealing opening 131′ are detachably engaged with each other via the first and second zippers 211′, 212′ to seal and enclose the respective sealing pocket 13′.

Each of the zipper lockers 21′ further comprises a slider 213′ slidably engaging with the first and second zippers 211′, 212′ to slide along each of the sealing opening 131′ so as to ensure the first and second zippers 211′, 212′ being secured with each other. Accordingly, when the zip slider 213′ is slid at one end of the sealing opening 131′, the first and second zippers 211′, 212′ are disengaged with each other to unseal and open the respective sealing pocket 13′. When the zip slider 213′ is slid at another opposed end of the sealing opening 131′, the first and second zippers 211′, 212′ are engaged with each other to seal and enclose the respective sealing pocket 13′.

It is worth to mention that the discrete sealing pockets 13′ has the discrete sealing opening 131′ having the respective zip locker 21′ provided thereat, wherein each of the sealing pockets 13′ is able to be enclosed and opened individually by sliding the zip slider 213′ of the zip locker 21′. Therefore, the individual zip lockers 21′ provided at the individual sealing openings 131′ for sealing each sealing pockets 13′ enables the user to enclose and open the container bag in a reusable manner and to enable the sealing pockets 13′ being enclosed or opened individually to avoid the unnecessary opening of the sealing pockets 13′ which is not desired to reach. It is appreciated that when the zip locker 21′ is closed, the three sealing edges and the sealable edge having the zip locker 21′ provided at the sealing opening 131′ are formed the air-tight chamber 132′ to securely seal the foods into the respective sealing pocket 13′.

It is worth to mention that the container bag according to the first and second embodiments can be manufactured via the conventional manufacturing method which provides two rolls of flexible sheets. By overlapping the flexible sheets with each other and forming the resealable lock 20, 20′, the first and second layers 11, 12, 11′, 12′ with the built-in first and second zippers 21, 21′ are formed. Then, by cutting and heat-sealing the two flexible sheets in a predetermined dimension, the container bag can be manufactured with multiple sealing pockets 13, 13′.

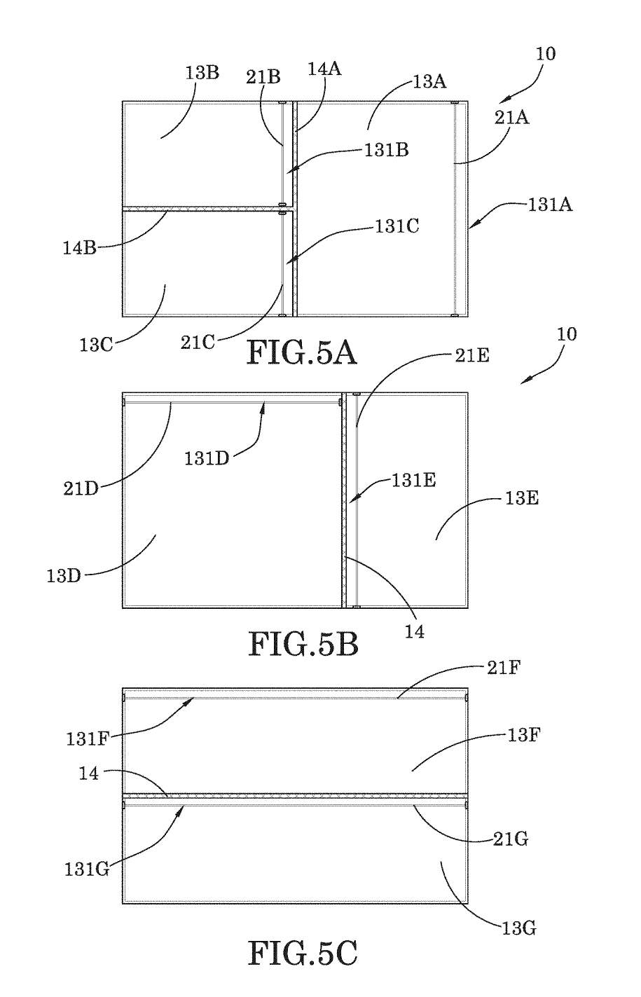

Referring to FIGS. 5A to 5C of the drawings, the container bag can have different pocket configurations according to the above first and second preferred embodiments. Accordingly, at least two of the sealing openings 131, 131′ of the sealing pockets 13, 13′ are extended in a parallel manner. It is appreciated that one of the sealing opening 131, 131′ is extended perpendicularly to another sealing opening 131, 131′.

An example is shown in FIG. 5A to illustrate the first alternative pocket configuration. The bag body 10 provides three sealing pockets 13A, 13B, 13C, wherein the first sealing pocket 13A has a size larger than the size of each of the second and third sealing pockets 13B, 13C, while the second and third sealing pockets 13B, 13C are identical.

In other words, the larger first sealing pocket 13A is combined with two smaller second and third sealing pockets 13B, 13C to form a first alternative pocket configuration. Since the bag body 10 provides three sealing pockets 13A, 13B, 13C, there are three sealing openings 131A, 131B, 131C and three zip lockers 21A, 21B, 21C.

The bag body 10 has a first sealing portion 14A provided along the centerline of the bag body 10 to form a first partition between the first sealing pocket 13A and the second and third sealing pockets 13B, 13C. A second sealing portion 14B is perpendicularly extended from the first sealing portion 14A to form a second partition between the second and third sealing pockets 13B, 13C.

The first zip locker 21A is provided along the first sealing opening 131A of the first sealing pocket 13A along the peripheral edge of the bag body 10. A second zip locker 21B and a third zip locker 21C are provided at the second sealing openings 131B of the second sealing pocket 13B and the first sealing opening 131C of the third sealing pocket 13C respectively, wherein the second zip locker 21B and the third zip locker 21C are aligned with each other end-to-end. In addition, the second and third zip lockers 21B, 21C are extended along the second and third sealing openings 131B, 131C respectively at a position adjacent and parallel to the first sealing portion 14A. In addition, the second and third zip lockers 21B, 21C are extended parallel to the first zip locker 21A. Therefore, three independent sealing pockets 13A, 13B, 13C are formed to provide the individual air-tight chambers to securely seal the items therein while each of the sealing pockets 13A, 13B, 13C can be opened individually via the respective zip locker 21A, 21B, 21C.

Another example is shown in FIG. 5B to illustrate the second alternative pocket configuration. The bag body 10 provides two sealing pockets 13D, 13E side-by-side, wherein the first sealing pocket 13D has a size larger than the size of the second sealing pocket 13E. In other words, since the bag body 10 provides two sealing pockets 13D, 13E, there are two sealing openings 131D, 131E and two zip lockers 21D, 21E. The bag body 10 has a sealing portion 14 provided along the centerline of the bag body 10 to form a partition between the first sealing pocket 13D and the second sealing pocket 13E.

The first zip locker 21 is provided along the first sealing opening 131D of the first sealing pocket 13D along the peripheral edge of the bag body 10. A second zip locker 21E is provided at the second sealing openings 131E of the second sealing pocket 13E. In addition, the second zip locker 21E is extended along the second sealing opening 131E at a position adjacent and parallel to the sealing portion 14. In addition, the second zip locker 21E is extended perpendicularly to the first zip locker 21D. Therefore, two independent sealing pockets 13D, 13E are formed to provide the individual air-tight chambers to securely seal the items therein while each of the sealing pockets 13D, 13E can be opened individually via the respective zip locker 21D, 21E.

Another example is shown in FIG. 5C to illustrate the third alternative pocket configuration. The bag body 10 provides two sealing pockets 13F, 13G as a top pocket and a bottom pocket, wherein the first and second sealing pockets 13F, 13G are identical in size and shape. Since the bag body 10 provides two sealing pockets 13F, 13G, there are two sealing openings 131F, 131G and two zip lockers 21F, 21G. The bag body 10 has a sealing portion 14 provided along the centerline of the bag body 10 to form a partition between the first sealing pocket 13F and the second sealing pocket 13G.

The first zip locker 21F is provided along the first sealing opening 131F of the first sealing pocket 13F along the peripheral edge of the bag body 10. A second zip locker 21G is provided at the second sealing openings 131G of the second sealing pocket 13G. In addition, the second zip locker 21G is extended along the second sealing opening 131G at a position adjacent and parallel to the sealing portion 14. In addition, the second zip locker 21G is extended parallel to the first zip locker 21D. Therefore, two independent sealing pockets 13F, 13G are formed to provide the individual air-tight chambers to securely seal the items therein while each of the sealing pockets 13F, 13G can be opened individually via the respective zip locker 21F, 21G.

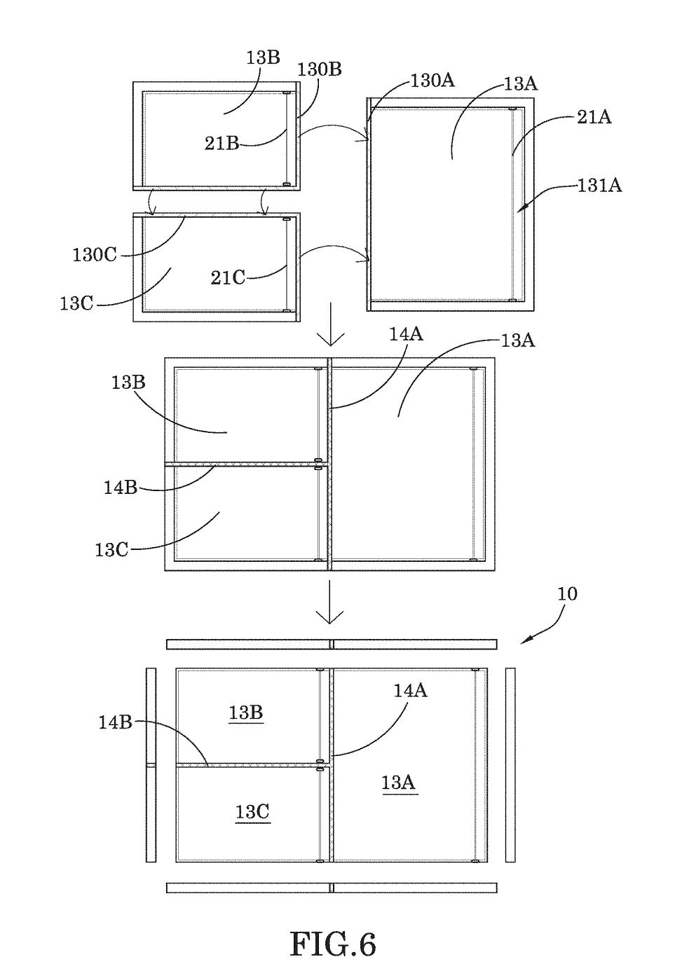

In order to manufacture the container bag with multiple sealing pockets 13, the present invention further provides a manufacturing process to make the container bag, as shown in FIG. 6. As an example shown in FIG. 5A, the three sealing pockets 13A, 13B, 13C are formed individually via the conventional process of the container bag. Accordingly, each of the sealing pockets 13A, 13B, 13C has a peripheral margin portion 130A, 130B, 130C remained uncut.

Accordingly, the margin portion 130B, 130C of the second and third sealing pockets 13B, 13C are overlapped and sealed with the margin portion 130A of the first sealing pocket 13A to form the first sealing portion 14A of the bag body 10. The margin portion 130B of the second sealing pocket 13B is overlapped and sealed with the margin portion 130C of the third sealing pocket 13C to form the second sealing portion 14 of the bag body 10. Then, the rest of the margin portions 130A, 130B, 130C of the sealing pockets 13A, 13B, 13C will be cut to trim the margin edge of the bag body 10 such that the container bag having multiple sealing pockets and multiple sealable locks is formed. Accordingly, the container bag with multiple sealable locks can be produced in the way which is similar to the conventional producing method without other special machine or complicated steps involving, so as to minimize the manufacturing cost of the container bag.

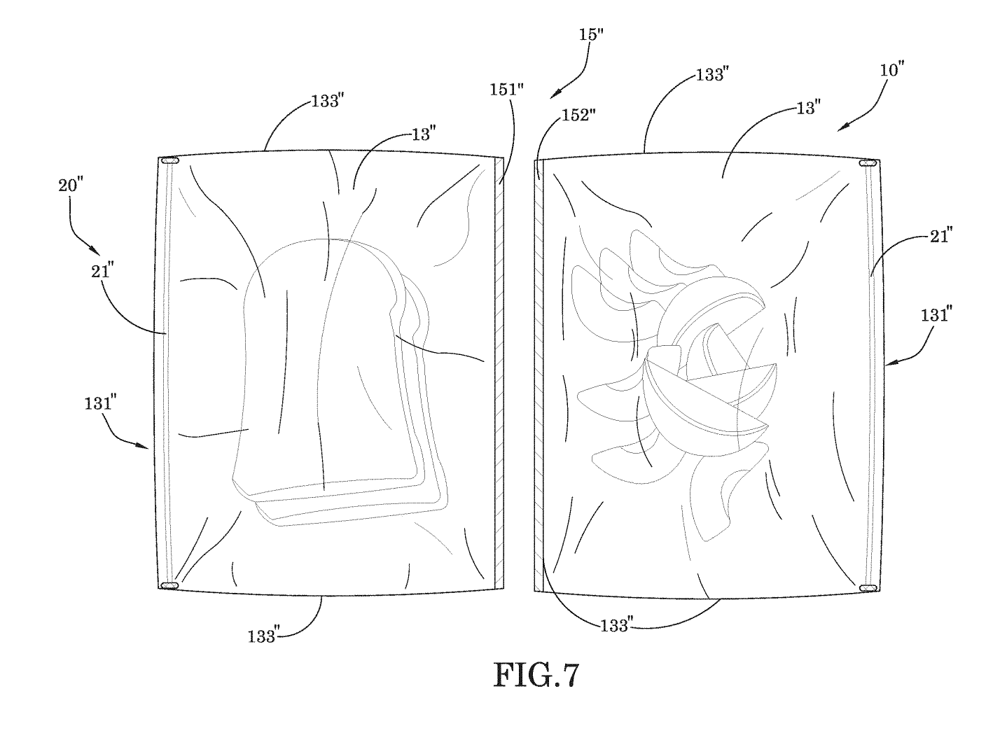

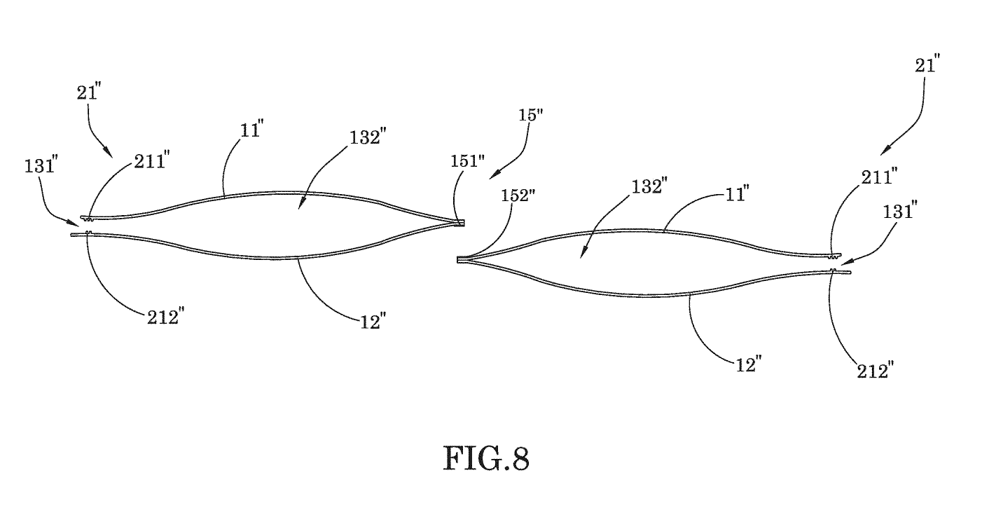

Referring to FIGS. 7 and 8 of the drawings, a container bag according to a third embodiment of the present invention is illustrated, wherein the container bag, having the similar structure of the first and second embodiments, comprises a bag body 10″ and a resealable lock 20″.

The bag body 10″ comprises a first layer 11″ and a second layer 12″ overlapped therewith, and defines a plurality of sealing pockets 13″ discretely provided between the first layer 11″ and the second layer 12″ and a plurality of elongated sealing openings 131″ for communicating with the sealing pockets 13″ respectively.

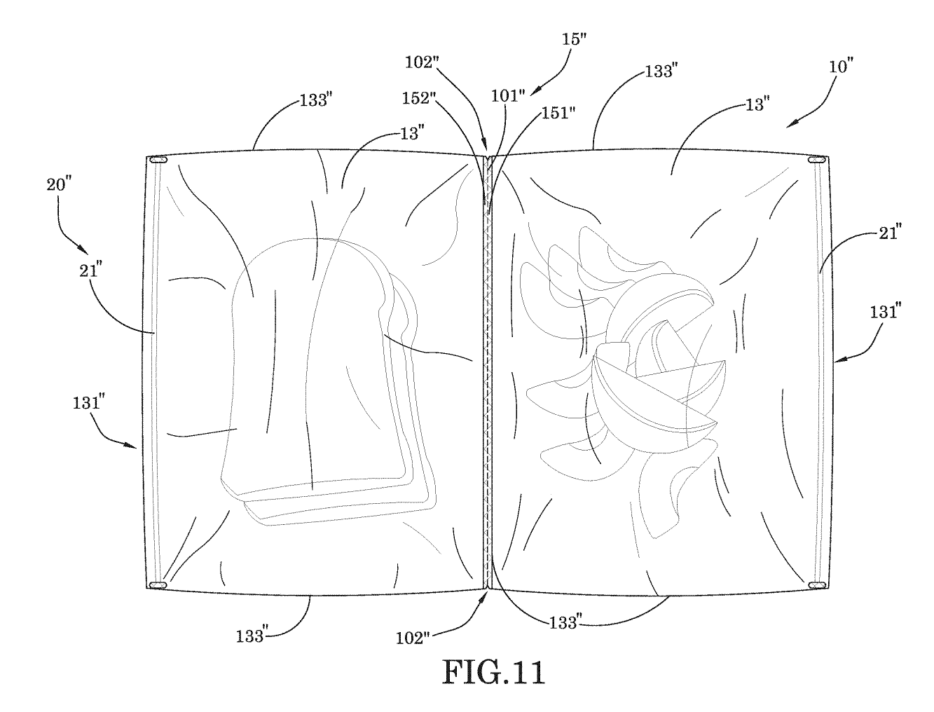

As shown in FIG. 11, the bag body 10″ further has a tearing line 101″ extending therealong between the sealing pockets 13″, wherein the sealing pockets 13″ are adapted to be torn off along the tearing line 101″ to form the discrete sealing pockets 13″. In addition, the bag body 10″ further has a tearing notch 102″ formed at one end of the tearing line 101″ such that the user is able to separate the sealing pockets 13″ by tearing along the tearing line 101″ starting at the tearing notch 102″. It is appreciated that the tearing line 101″ and the tearing notch 102″ can be provided at the bag body 10, 10′ of the first and second embodiments to allow the sealing pockets 13, 13″ being detached from each other. Accordingly, the tearing line 101″ is preferably formed along the sealing portion 14, 14′ of the bag body 10, 10′ according to she first and second embodiments.

According to the a third preferred embodiment of the present invention, the sealing pockets 13″ can be used individually just like conventional container bags. But a group of sealing pockets can be detachably assembled together to form a one bag body 10″.

The resealable lock 20″ comprises a plurality of zip lockers 21″ provided at the sealing openings 131″ respectively to seal and enclose the sealing pockets 13″, wherein each of the zip lockers 21″ is individually actuated to unsealed and open the sealing pocket 13″ so as to permit each of the sealing pockets 13″ being reclosably sealed in a reusable manner. Each of the sealing pockets 13″ has an air-tight chamber 132″ when the sealing opening 131″ is sealed via the respective zip locker 21″.

Each of the sealing pockets 13″, which is preferably formed in a rectangular shape, has three sealing edges 133″ and a sealable edge to define the sealing opening 131″ therealong. In other words, the three sealing edges 133″ of each of the sealing pockets 13″ are permanently sealed while the zip locker 21″ is provided at the sealable edge of the sealing pocket 13″. Accordingly, at least one of the sealing openings 131″ is formed along a peripheral edge of the bag body 10″.

As it is mentioned in the first embodiment, each of the zipper lockers 21″ comprises a first zipper 211″ integrally provided along an opening edge of each of the sealing openings 131″ at the first layer 11″ and a second zipper 212″ integrally provided along an opening edge of the respective sealing opening 131″ at the second layer 12″ to detachably engage with the first zipper 211″ so as to seal and enclose the respective sealing pocket 13″. Accordingly, the two opening edges of each of the sealing opening 131″ are detachably engaged with each other via the first and second zippers 211″, 212″ to seal and enclose the respective sealing pocket 13″.

As an alternative mode of the first and second embodiments, the sealing pockets 13″ of the third embodiment can be physically separated from each other. In another word, the sealing pockets 13″ are not permanently affixed together.

As shown in FIG. 7, the container bag further comprises a detachable fastening arrangement 15″ for detachably fastening the sealing pockets 13″ edge-to-edge in a selectively re-arranging manner, so as to adjustably arrange the combination-configuration of the bag body 10″.

As shown in FIGS. 7 and 8, the detachable fastening arrangement 15″ comprises a first fastener 151″ and a second fastener 152″ selectively provided at the edges of the sealing pockets 13″ respectively and detachably fastened with each other. Accordingly, the first fastener 151″ is provided along at least one edge of each of the sealing pocket 13″ while the corresponding second fastener 152″ provided along another edge of each of the sealing pocket 13″ to detachably fasten with the first fastener 151″ so as to detachably fasten the sealing pockets 13″ with each other edge-to-edge. The first and second fasteners 151″, 152″ are selectively provided along the sealing edges 133″ and the sealable edge to detachably couple the sealing pockets 13″ edge-to-edge.

As shown in FIG. 11, the first and second fasteners 151″, 152″ are formed adjacent to the tearing line 101″ of the bag body 10″ such that after the bag body 10″ is torn off along the tearing line 101″ to separate the sealing pockets 13″, the sealing pockets 13″ are adapted to couple with each other via the first and second fasteners 151″, 152″. In other words, the bag body 10″ is initially formed in a one piece structure to integrally couple the sealing pockets 13″ with each other. The user is able to separate the sealing pockets 13″ by tearing along the tearing line 101″ and to re-couple the sealing pockets 13″ by fastening the first and second fasteners 151″, 152″.

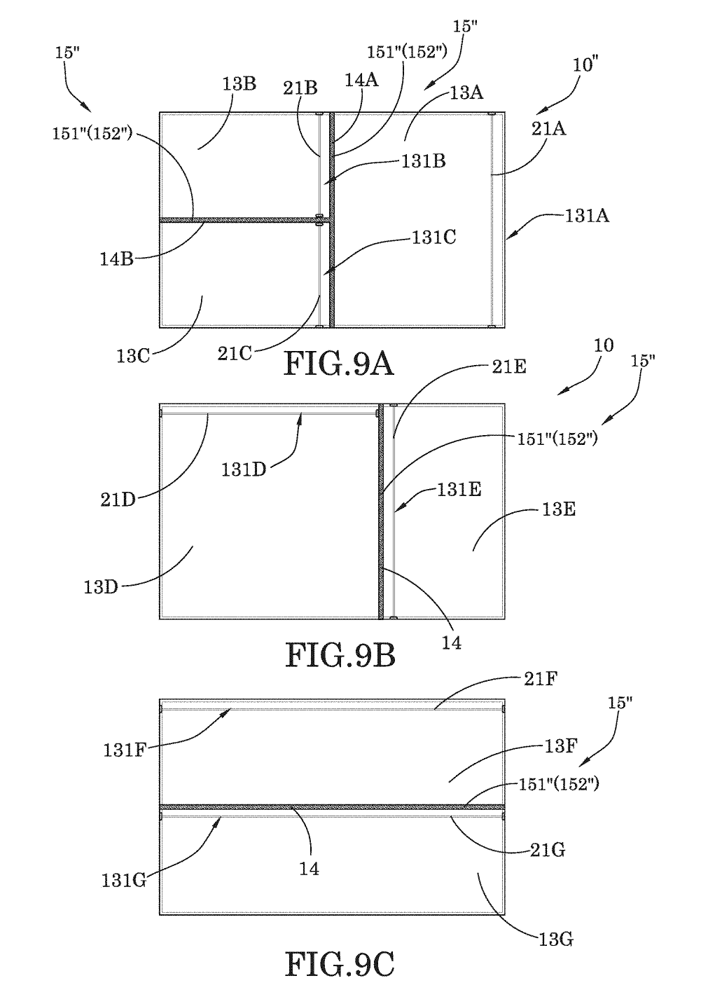

As shown in FIG. 8, the first and second fasteners 151″, 152″ are identical and are detachably fastened with each other. Accordingly, the first and second fasteners 151″, 152″ are two adhering layers provided along the edges of the sealing pockets 13″ respectively, wherein the adhering layers are adapted to re-coupled with each other and are adapted to re-detach from each other. In other words, the adhering layers can be integrally provided along the edges of the sealing pockets 13″ that the adhering layers can be reusably coupled with each other. Therefore, the user is able to selective re-arrange the configuration of the bag body 10″ by detachably coupling the sealing pockets 13″ in different formations or combinations, as shown in FIGS. 9A to 9C.

Similar to FIGS. 5A to 5C of the above first and second preferred embodiments as an example, the container bag can have different pocket combination-configurations illustrated in FIGS. 9A to 9C. Accordingly, at least two of the sealing openings 131″ of the sealing pockets 13″ are extended in a parallel manner. It is appreciated that one of the sealing opening 131″ is extended perpendicularly to another sealing opening 131″.

An example is shown in FIG. 9A to illustrate the first alternative pocket combination-configuration. The bag body 10″ provides three sealing pockets 13A, 13B, 13C, wherein the first sealing pocket 13A has a size larger than the size of each of the second and third sealing pockets 13B, 13C, while the second and third sealing pockets 13B, 13C are identical.

In other words, the larger first sealing pocket 13A is combined with two smaller second and third sealing pockets 13B, 13C to form a first alternative pocket configuration. Since the bag body 10″ provides three sealing pockets 13A, 13B, 13C, there are three sealing openings 131A, 13B, 13C and three zip lockers 21A, 21B, 21C.

The first fastener 151″ is provided at one of the edges of the first sealing pocket 13A and the second fasteners 152″ are provided at the corresponding edges of the second and third sealing pockets 13B, 13C respectively to detachably couple the first sealing pocket 13A with the second and third sealing pockets 13B, 13C at the first combining portion 14A. In addition, the first and second fasteners 151″, 152″ are provided the corresponding edges of the second and third sealing pockets 13B, 13C respectively to detachably couple the second sealing pocket 13B with the third sealing pocket 13C at the second combining portion 14B.

The first zip locker 21A is provided along the first sealing opening 131A of the first sealing pocket 13A along the peripheral edge of the bag body 10″. A second zip locker 21B and a third zip locker 21C are provided at the second sealing openings 131B of the second sealing pocket 13B and the first sealing opening 131C of the third sealing pocket 13C respectively, wherein the second zip locker 21B and the third zip locker 21C are aligned with each other end-to-end. Therefore, three independent sealing pockets 13A, 13B, 13C are formed to provide the individual air-tight chambers to securely seal the items therein while each of the sealing pockets 13A, 13B, 13C can be opened individually via the respective zip locker 21A, 21B, 21C and can be detached from each other via the detachable fastening arrangement 15″.

Another example is shown in FIG. 9B to illustrate the second alternative pocket combination-configuration. The bag body 10″ provides two sealing pockets 13D, 13E side-by-side, wherein the first sealing pocket 13D has a size larger than the size of the second sealing pocket 13E. In other words, since the bag body 10 provides two sealing pockets 13D, 13E, there are two sealing openings 131D, 131E and two zip lockers 21D, 21E.

The first and second fasteners 151″, 152″ are provides tbe corresponding edges of the first and second sealing pockets 13D, 13E respectively to detachably couple the first sealing pocket 13D with the second sealing pocket 13E at the combining portion 14.

The first zip locker 21D is provided along the first sealing opening 131D of the first sealing pocket 13D along the peripheral edge of the bag body 10. A second zip locker 21E is provided at the second sealing openings 131E of the second sealing pocket 13E. In addition, the second zip locker 21E is extended along the second sealing opening 131E at a position adjacent and parallel to the sealing portion 14. In addition, the second zip locker 21E is extended perpendicularly to the first zip locker 21D. Therefore, two independent sealing pockets 13D, 13E are formed to provide the individual air-tight chambers to securely seal the items therein while each of the sealing pockets 13D, 13E can be opened individually via the respective zip locker 21D, 21E and can be detached from each other via the detachable fastening arrangement 15″.

Another example is shown in FIG. 9C to illustrate the third alternative pocket combination-configuration. The bag body 10″ provides two sealing pockets 13F, 13G as a top pocket and a bottom pocket, wherein the first and second sealing pockets 13F, 13G are identical in size and shape. Since the bag body 10″ provides two sealing pockets 13F, 13G, there are two sealing openings 131F, 131G and two zip lockers 21F, 21G.

The first and second fasteners 151″, 152″ are provided the corresponding edges of the first and second sealing pockets 13F, 13G respectively to detachably couple the first sealing pocket 13F with the second sealing pocket 13G at the combining portion 14.

The first zip locker 21F is provided along the first sealing opening 131F of the first sealing pocket 13F along the peripheral edge of the bag body 10″. A second zip locker 21G is provided at the second sealing openings 131G of the second sealing pocket 13G. In addition, the second zip locker 21G is extended along the second sealing opening 131G at a position adjacent and parallel to the sealing portion 14. In addition, the second zip locker 21G is extended parallel to the first zip locker 21D. Therefore, two independent sealing pockets 13F, 13G are formed to provide the individual air-tight chambers to securely seal the items therein while each of the sealing pockets 13F, 13G can be opened individually via the respective zip locker 21F, 21G and can be detached from each other via the detachable fastening arrangement 15″.

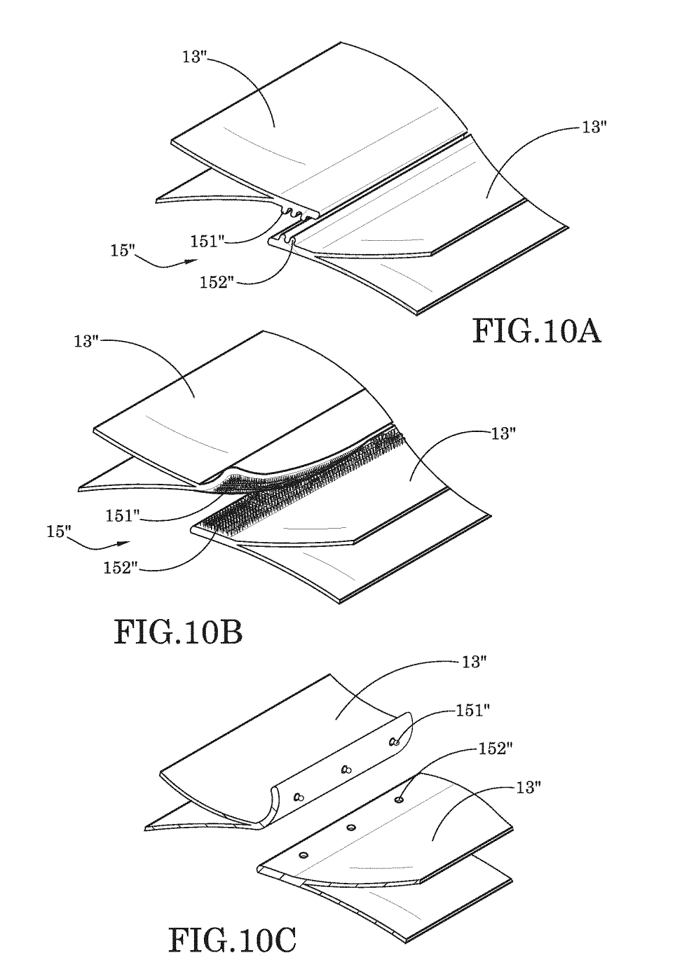

FIGS. 10A to 10C illustrate the alternative modes of the detachable fastening arrangement 15″ to re-arrange the combination-configuration of the bag body 10″. As shown in FIG. 10A, the first and second fasteners 151″, 152″ are first and second zippers provided at the edges of the sealing pockets 13″ respectively, wherein the first and second zippers are detachably fastened with each other to detachably couple the sealing pockets 13″ with each other. As shown in FIG. 10B, the first and second fasteners 151″, 152″ are hook and loop fasteners provided at the edges of the sealing pockets 13″ respectively, wherein the hook and loop fasteners are detachably fastened with each other to detachably couple the sealing pockets 13″ with each other.

As shown in FIG. 10C, the first and second fasteners 151″, 152″ are snap buttons and button holes provided at the edges of the sealing pockets 13″ respectively, wherein the snap buttons and button holes are detachably fastened with each other to detachably couple the sealing pockets 13″ with each other. Accordingly, the arrangement of the snap fastener has a standard such as a unique size and distance, therefore different sealing pockets 13″ can be assembled.

It is appreciated that each of the sealing pockets 13″ can have one or more first or second fasteners 151″, 152″. For example, both the first and second fasteners 151″, 152″ can provide at different sealing edges 133″ of the rectangular sealing pocket 13″. The sealing opening 131″ of the sealing pocket 13″ can have one of the first and second fasteners 151″, 152″ provided therealong. In this way, the present invention provides a big flexibility to assemble the sealing pockets 13″ in different combination-configuration.

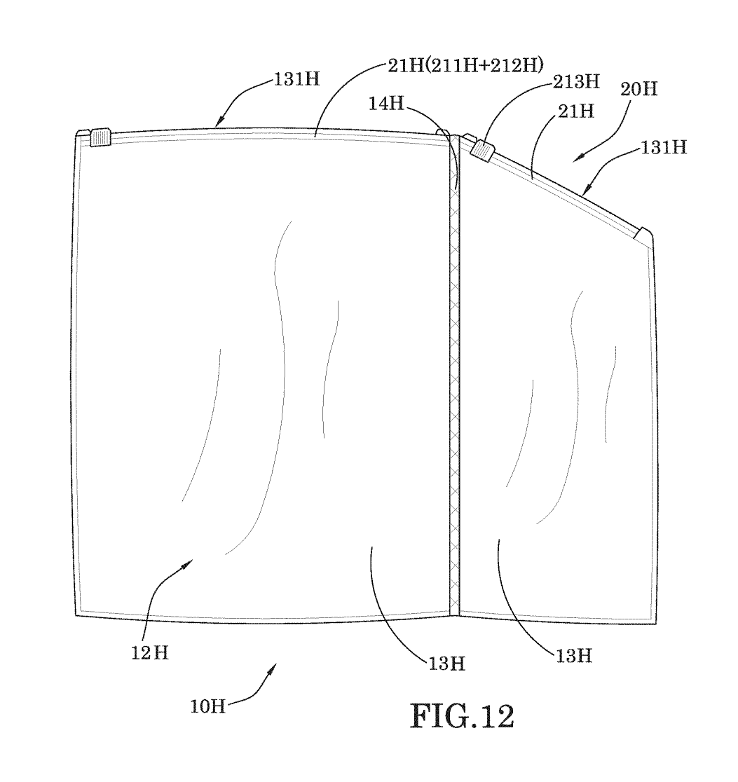

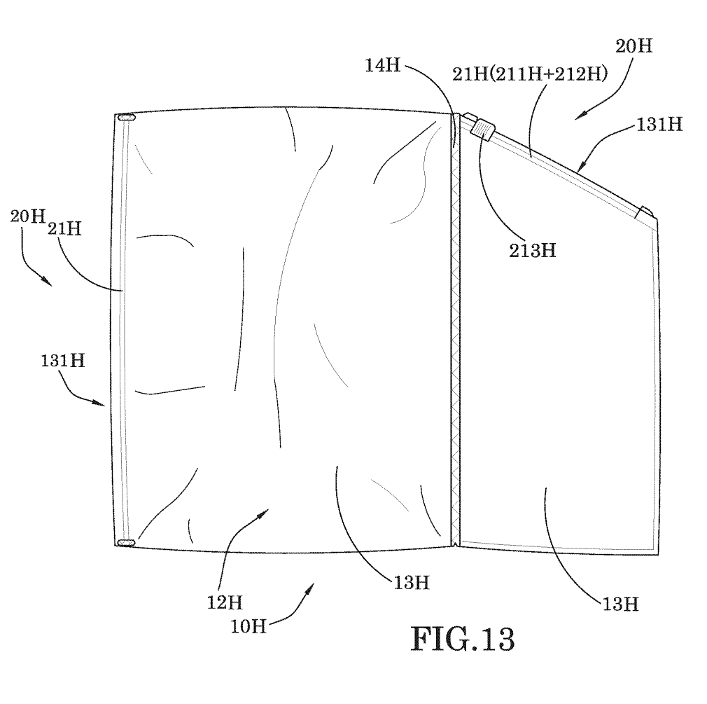

Referring to FIGS. 12 and 13 of the drawings, a container bag according to a fourth preferred embodiment of the present invention is illustrated, wherein the container bag having similar structure as above preferred embodiments comprises a container body 10H having a first layer 11H and a second layer 12H overlapped therewith, and define at least two sealing pocket 13H between the first and second layer 11H, 12H.

The sealing pocket 13H is discretely provided between the first and second layer 11H, 12H, wherein each of the sealing pockets 13H has an elongated sealing opening 131H for communicating with each of the sealing pockets 13H, so as to access an object received therewithin. Two of the sealing openings are preferably formed non-parallel with each other.

The container body may also have a resealable lock 20H, which comprises a plurality of zip lockers 21H provided along the edge of sealing openings 131H for sealing and enclosing the sealing pockets 13H so as to permit each of the sealing pockets 13H being reclosably seated in a resealable manner.

Accordingly, in the preferred embodiment, at least one of the sealing openings 131H of the sealing pockets 13H is preferably inclined with respect to another sealing pocket 13H for increasing a length of the inclined sealing opening 131H, such that when the zip locker 21H is actuated to unseal the sealing opening 131H, a diameter of the sealing opening is enlarged for conveniently accessing and communicating with the sealing pocket 13H. In other words, at least one of the sealing opening 131H is inclined to extend non-parallely to another sealing opening 131H to increase the length of the inclined sealing opening.

As shown in FIG. 12, two neighboring sealing pockets 131H, a first sealing pocket 13H and a second sealing pocket 13H, are illustrated as a first example of the fourth preferred embodiment of the inclined sealing opening 131H, wherein the second sealing opening 131H of the second sealing pocket 13H is inclined to increase the length thereof in an inclined manner. Therefore, the inclined second sealing opening 131 is also formed a trapezoid shaped sealing pockets 13H, wherein the inclined sealing opening 131H is preferably form at one of the two edges of a non-parallel pair edges of the trapezoid shape.

More specifically, the inclined second sealing opening 131H is preferably formed at the relatively longer side of the two edges of the non-parallel pair edges of the trapezoid shape, so that the inclined sealing opening 131H is able to maximize the length thereof. In other words, the inclined second sealing opening 131H is formed at a slanted edge of the trapezoid shaped second sealing pocket 13H in the inclined manner.

In the first example, one of the sealing opening 131H is horizontally formed at the first sealing pocket 13H while the second sealing opening 131H is inclinedly extended at the second sealing pocket 13H to increase the length of the sealing opening 131H.

Accordingly, the first sealing opening 131H is connected to the second sealing opening 131 in an end-to-end manner, wherein a sealing portion 14H permanently sealing the first and second layer 11H, 12H is further provided between the first and second sealing pocket 13H to form a partition therebetween, so as to form two individual zip lockers 21H at the first and second sealing openings 131H respectively. Thus, the zip lockers 21H are able to be individually actuated to unseal and open each of the sealing pockets 13H. In other words, the zipper lockers 21H are extended in the end-to-end manner and are able for being independently actuated for enclosing each of the sealing pockets 13H via the partition of the sealing portion 14. It is appreciated that more than one sealing portions 14H may be provided for forming more than two sealing pockets 13H, so as to form the discretely sealing pockets 13H between the first and second layers 11H, 12H.

As mentioned above, the first sealing pocket 13H is preferably has a rectangular shape and has a zip locker 21H horizontally provided at the first sealing opening 131H. The second sealing pocket 13H has a substantially trapezoid shape to form the two edges of non-parallel pair of the trapezoid sides, such that the second sealing opening 131H is formed at the slanted edge of the trapezoid shaped second sealing pocket 13H to increase the length of the sealing opening 131H.

As shown in FIG. 13, a second example according to the fourth preferred embodiment with two sealing pockets 13H having similar structure as the above example is illustrated, wherein the first sealing opening 131H is formed at a rectangular shaped first sealing pocket 13H while the second sealing opening is inclinedly formed at the second sealing pockets 13H, so as to increase the length of the second sealing opening 131 of the second sealing pocket 13.

The first sealing opening 131H is extended vertically at the first sealing pocket 13H, while the second sealing opening 131H is inclinedly extended at the second sealing pocket 13H with respect of the first sealing opening 131H to increase the length of the second sealing opening 131H. In other word, the second sealing pocket 13H preferably has a trapezoid shape forming the inclined second sealing opening 131H at the slanted edge of the trapezoid shaped second sealing pocket 131H.

More specifically, the first sealing opening is preferably extended vertically along one of the two vertical edges of the rectangular shaped first sealing pocket 13, while the second sealing opening 131 is inclined and provided at a relatively longer edge of the two edges of the non-parallel pair of the trapezoid shape. Therefore, the first sealing opening and the second sealing opening 131 are formed an inclining angle therebetween, which is smaller than 90°. The first and second zip lockers 21H thus are formed at the first and second sealing opening 131H respectively for being independently actuated for individually communicating with each of the sealing pockets 13H.

At least one sealing portion 14H that the first layer 11H is permanently sealed with the second layer 12H to form a partition between the two neighboring sealing pockets 13H, so as to form two individual zip lockers 21H of the two adjacent sealing pockets. Therefore, the zip lockers 21H are able to be independently actuated for accessing the object received within each of the sealing pockets 13H.

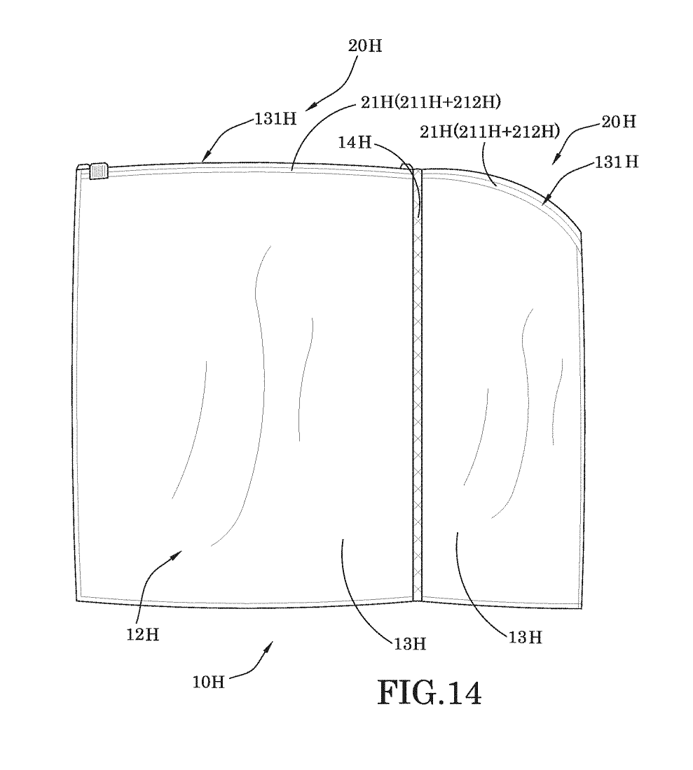

Referring to FIG. 14 of the drawings, an alternative of the container bag according to the fourth preferred embodiment is illustrated, wherein the first and second layer 11H, 12H are overlapped to form at least two sealing pockets 13H therebetween. Each of the sealing pockets 13H has an elongated sealing opening 131H for communicatively accessing a receiving cavity within the sealing pockets 13H. Each of the zip lockers 21H of the sealable lock 20H are provided along each of the elongated sealing opening 131H for accessing the receiving cavity of the sealing pockets 13H in a resealable manner.

Accordingly, one of the sealing opening 131H of two neighboring sealing pockets 13H has a curved configuration to increase a length of the sealing opening 131H in an arc-shaped manner, while the other sealing opening 131H is extended in a non-parallely manner with respect to the curved sealing opening 131H, such as extended in vertical or horizontal manner. The curved sealing opening 131H may further be inclined while forming the curve shaped sealing opening 131H for further increasing the length of the curved sealing opening 131H. The curved sealing opening 131H of the inclined sealing opening 131H is preferably formed along one of the peripheral edges of the container body 10H, so as to increase the length of the sealing opening 131H.

As shown in FIG. 14, an example is illustrated with two sealing pockets 13H, a first and a second sealing pockets 13H, formed between the first and second layer 11H, 12H, wherein the curved sealing opening 131H is preferably formed at a second sealing opening 131H of the second sealing pocket 13H, so that a relatively longer length of the curved sealing opening 131H is formed for conveniently accessing the sealing pocket 13H through the increased length of sealing opening 131H.

As mentioned above, the sealing opening 131H in this example is horizontally formed at the first sealing pocket 13H while the sealing opening 131H is extended in a curved configuration at the second sealing pocket 13H to increase the length of the sealing opening 131H at the second sealing pocket 13H in the arc-shaped manner. Therefore, the zip lockers 21H of the first and second sealing pockets 13H are extended end-to-end and are independent actuated to seal and enclose the sealing pockets 13H respectively.

The bag body 10H further has at least one sealing portion 14H that the first layer 11H is permanently sealed with the second layer 12H to form a partition between the two neighboring sealing pockets 13H, so as to form two individual zip lockers 21H of the two adjacent sealing pockets 13H. It is worth to mention that the partition of the sealing portion 14H also formed the independently actuating zip lockers 21H for individually accessing the sealing pockets 13H.

It is appreciated that each of the sealing openings from all of the above examples of the preferred embodiments is preferably a discrete opening formed at the bag body 10H that each of the sealing pockets 13H has an air-tight chamber when the sealing opening is sealed via the respective zip locker 21H, such that the each of the sealing pockets 13H formed the air-tight chamber is inaccessible to another air-tight chamber of each of the neighboring sealing pocket 13H.

It will be readily appreciated that the inclined and/or curved sealing openings 131 of the examples of FIGS. 12 to 14 of the preferred embodiment of the present invention are interchangeable. The sealing pockets 13H of the container body may have the curved sealing opening 131H and inclined sealing opening 131H at the same time for increasing the length thereof. The sealing opening 131H may also has variety of non-straight line shape in order to increase the length of the sealing opening 131H.

It is appreciated that each of the above zipper lockers 21H may further comprises a first and a second zippers 211H, 212H and a zip slider 213H slidably engaging with the first and second zippers 211H, 212H, which is provided along the sealing opening 131H at the first and second layers 11H, 12H respectively, to slide along each of the sealing openings 131H, so as to ensure the first and second zippers 211H, 212H being secured with each other.

Accordingly, when the zip slider 213H is slid at one end of the sealing opening 131H, the first and second zippers 211H, 212H are disengaged with each other to unseal and open the respective sealing pocket 13H. When the zip slider 213H is slid at another opposed end of the sealing opening 131H, the first and second zippers 211H, 212H are engaged with each other to seal and enclose the respective sealing pocket 13H, so as to form the air-tight chamber of each of the sealing pockets 13H. The first and second zippers 211H, 212H may be manually actuated by applying a pressing force to engage and disengage the first and second zippers 211H, 212H for seal or unseal the zip lockers 21H respectively.

In order to further illustrate the function of the container bag, an example of using the container bag as a salad bag is described as following. The salad bag of the container bag has at least two sealing pockets, wherein one of the sealing pockets is a vegetable bag adapted for containing the vegetables while the other sealing pocket is dressing bag adapted for containing the salad dressing. The tearing line 101″ illustrated in FIG. 11 is able to be further provided between any two neighboring sealing pockets shown from FIGS. 1 to 14 at the sealing portion therebetween, so that the dressing bag is able to be detached for pulling the salad dressing therewithin into the vegatables in the vegetable bag.

Take tbe container bag shown in FIG. 12 as the example for using the container bag as the salad bag, wherein the tearing line 101″ is further provided between the first and the second sealing pocket 13H (not shown in FIG. 12) for detaching the second sealing pocket 13H from the first sealing pocket 13H. The first sealing pocket 13H is adapted as the vegetable bag preferably for containing the vegetables of salad, and the second sealing pocket 13H is adapted as the dressing bag preferably for containing the salad dressing therewithin.

Therefore, the first sealing pocket 13H is filling in the vegetables of the salad while the second sealing pocket 13H is filling in the salad dressing. The vegetables and the salad dressing are resealably sealed and enclosed within the vegetable bag of the first sealing pocket 13H and within the dressing bag of the second sealing pocket 13H respectively. Thus, the dressing bag of the second sealing pocket 13H is able to be detached from the vegetable bag of the first sealing pocket 13H and opened via the zip locker 21H for pulling out the salad dressing therein.

The vegetable bag of the first sealing pocket 13H is able to be reclosably opened via the zip locker 21H at the sealing opening, so that the salad dressing within the dressing bag of the second sealing pocket 13H is able to be pulled into the vegetable bag for mixing with the vegetables therewithin.

It is worth to mention that the vegetable bag of the first sealing pocket 13H of the salad bag is able to be resealed or relocked via the resealable zip locker 13H at the sealing opening 131H, so that after the salad dressing is being pulled into the vegetable bag, the zip locker 13H is able to reseal the first sealing pocket 13H for well-mixing the vegetable with the salad dressing therewithin, such as via shaking the sealed vegetable bag of the first sealing pocket 13H.

It is appreciated that the tearing line 101″ enables the dressing bag to be detached from the salad bag, so that the salad dressing within the dressing bag is able to be conveniently pulled into the salad bag for mixing with the vegetables therewithin. The tearing line 101″ may be provided between any two neighboring sealing pockets of the container bag shown in FIGS. 1 to 14 for forming the salad bag in this example.

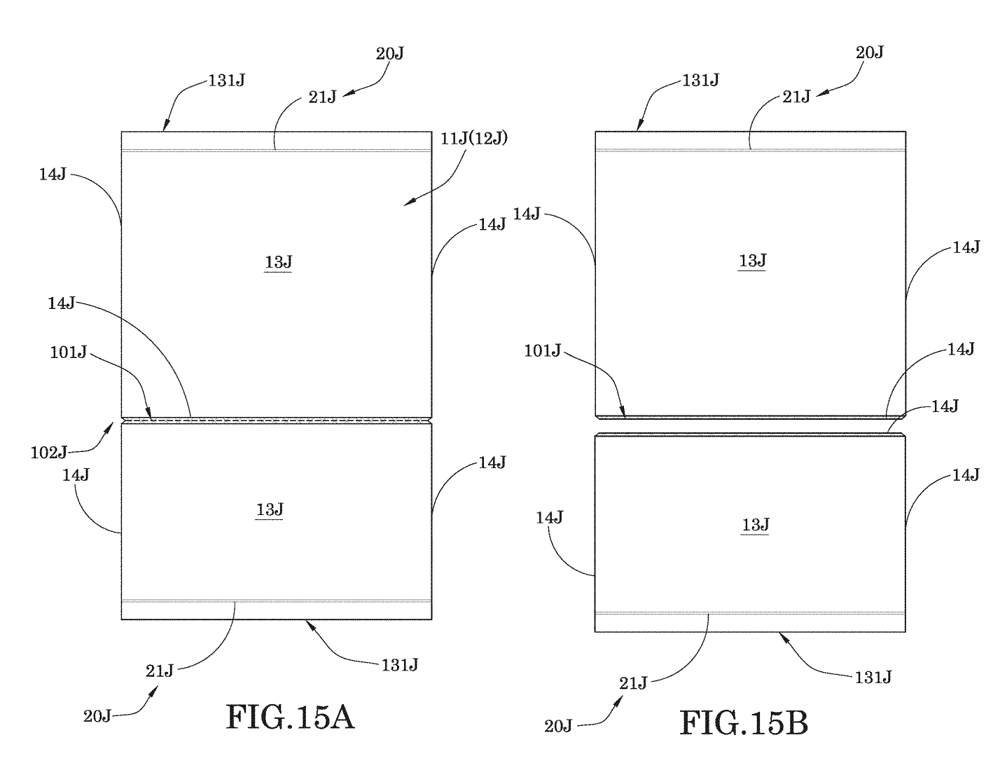

As shown in FIG. 15, a method of preparing a meal by the container bag is further illustrated, wherein the method comprises the steps of followings.

(a) Fill a first type food in a first sealing pocket 13 of the container bag.

(b) Fill a second type food in a second sealing pocket 13 of the container bag adjacent to the first sealing pocket 13.

(c) Tear the tearing line 101″ at the sealing portion between the first and second sealing pocket 13 for tearing apart the first and second sealing pocket 13.

(d) Resealably unseal the first and second sealing pocket 13.

(e) Pull the second type food within the second sealing pocket 13 into the first sealing pocket 13 for mixing with the first type food therewithin.

Take the vegetable of the salad and the salad dressing for example. The first type, food is embodied as vegetable being received within the first sealing pocket 13, while the second type food is embodied as salad dressing being filled within the second sealing pocket 13. After the sealing pockets 13 are filled with the first and second type food, the zip lockers 21 at the sealing openings 131 of the first and second sealing pocket 13 respectively are locked for sealing thereof.

Accordingly, the vegetable and the salad dressing of the first and second type food are able to be separately stored within the individual sealing pockets 13 of the container bag for prolong the preserving time of the food therewithin, so as to keep the food relatively more fresh. When the user is about to enjoy the salad meal, the tearing line 101″ is able to be tore for separating apart the dressing bag of the second sealing pocket 13 from the vegetable bag of the first sealing pocket 13, in such a manner that the zip lockers 21 at the first and second sealing pocket 13 is able to be unsealed for pulling the salad dressing within the second sealing pocket 13 into the first sealing pocket 13 for mixing with the vegetable therewithin for forming the salad meal.

In order to well-mix the second type food with the first type food, a step of resealing the zip locker 21 of the first sealing pocket 13 for well mixing the first and second type food. For example, well mix the salad dressing and the vegetable within first sealing pocket 13 by shaking or moving the first sealing pocket 13 back and forth or up and down.

It is worth to mention that the resealable zip lockers 21 of the first and second sealing pocket 13 are able to be resealed or relocked for storing the rest of the unconsumed first and/or second type food therewithin. Therefore, the container bag enables conveniently mixing the first and second type food to form the meal while storing the food in the container bag to optimize the freshness and maximize the shelf time of the food.

As will be readily appreciated that the second type food may be any other dressings or sauces for mixing with the first type food, such as pasta, potato, rice, and crackers etc., so that the food being contained within the container bag are able to be separately well-stored for prolong the shelf time of the food and optimizing the effectiveness of keeping the freshness of the food while being able to conveniently preparing the meal by mixing the first and second food when the user is able to enjoy the meal.

Three of more type of food may further being contained within the individual sealing pockets 13 of the container bag for mixing three or more type of food together for preparing the meal.

As shown in FIGS. 15A and 15B, the container body is modified to have an alternative pocket configuration of the above embodiments, wherein the container body comprises a bag body 10J and a resealable lock 20J.

The bag body 10J comprises a first layer 11J and a second layer 12J overlapped with each other, wherein the bag body 10J further has a plurality of sealing portions 14J provided thereat to form at least a first sealing pocket 13J and a second sealing pocket 13J discretely provided between the first layer 11J and the second layer 12J of the bag body 10J. Accordingly, three of the sealing portions 14J are provided at three sealing edges of the first sealing pocket and three of the sealing portions 14J are provided at three sealing edges of the second sealing pocket, such that each of the first sealing pocket and the second sealing pocket has an unsealed edge serving as an elongated opening 131J. In other words, each of the first and second sealing pockets 13J is formed in a rectangular shape.

The resealable lock 20J comprises a plurality of zip lockers 21J provided at the elongated openings 131J of the first sealing pocket 13J and the second sealing pocket 13J, wherein each of the first sealing pocket and the second sealing pocket is reclosably sealed by the resealable lock 20J. Preferably, the zip lockers 21J are zipper-type-reclosable fasteners integrally provided at the first and second layers 11J, 12J respectively along the sealing opening 131J thereof, wherein the user is able to fasten the zip locker 21J together through the zipper closure action as the user applies thumb and finger pressure in a sweeping motion across the zip locker 21J at the sealing opening 131J.

As shown in FIGS. 15A and 15B, the tearing line 101J is formed between the first sealing pocket 13J and the second sealing pocket 13J to allow the first sealing pocket 13J and the second sealing pocket 13J to be torn off along the tearing line 101J. In particular, the tearing line 131J is formed at the bag body 10J between the elongated openings 131J of the first sealing pocket 13J and the second sealing pocket 13J. It is worth mentioning that the tearing line 101J is formed along one of the sealing portions 14J of the bag body 10J. The sealing portion 14J where the tearing line 101J formed therealong is the common sealing portion between the first sealing pocket 13J and the second sealing pocket 13J. Therefore, when the first sealing pocket 13J and the second sealing pocket 13J are separated from each other, the zip lockers 21J are independent actuated to seal and enclose the first sealing pocket 13J and the second sealing pocket 13J respectively.

The tearing notch 102J is formed at one end of the tearing line 10J, wherein the tearing notch 102J serves as a tearing guidance, such that the user is able to easily separate the first sealing pocket 13J and the second sealing pocket 13J by tearing along the tearing line 101J starting at the tearing notch 102J.

As shown in FIGS. 15A and 15B, the elongated openings 131J of the first sealing pocket 13J and the second sealing pocket 13J at two opposite sides of the bag body 10J, such that said tearing line 101J is formed at the bag body 10J parallel to the elongated openings 131J of the first sealing pocket 13J and the second sealing pocket 13J. Accordingly, a size of the first sealing pocket 13J is larger than a size of the second sealing pocket 13J. For example, the first sealing pocket 13J serves as a salad bag and the second sealing pocket 13J serves as a dressing bag, such that the salad and the dressing are separated and sealed in the air-tight chambers of the first sealing pocket 13J and the second sealing pocket 13J respectively. Therefore, the user is able to carry one single container bag to separate the salad from the dressing before use. It is worth mentioning that each of the first and second sealing pockets 13J, 13J can be opened individually via the zip locker 21J. The user is able to detach the first sealing pocket 13J from the second sealing pocket 13J along the tearing line 101J and to apply the dressing from the second sealing pocket 13J to the first sealing pocket 13J for mixing the dressing with the salad.

Accordingly, the present invention further provides a method of manufacturing a container bag, comprising the following steps.

(1) Overlap and seal the first layer 11J and the second layer 12J with each other to form the bag body 10J. Preferably, the size and shape of the first layer 11J is identical to the size and shape of the second layer 12J. Each of the first layer 11J and the second layer 12J has a rectangular shape.

(2) Form at least one first sealing pocket 13J and one second sealing pocket 13J discretely provided between the first layer 11J and the second layer 12J of the bag body 10J. Accordingly, each of the first sealing pocket 13J and the second sealing pocket 13J has three sealing edges sealed by the sealing portions 14J respectively and an unsealed edge serving as the elongated opening 131J.

(3) Provide the resealable lock 20J at the elongated opening 131J of each of the first sealing pocket 13J and the second sealing pocket 13J, wherein each of the first sealing pocket 13J and the second sealing pocket 13J is reclosably sealed by the resealable lock 20J.

(4) Form the tearing line 101J between the first sealing pocket 13J and the second sealing pocket 13J to allow the first sealing pocket 13J and the second sealing pocket 13J to be torn off along the tearing line 101J.

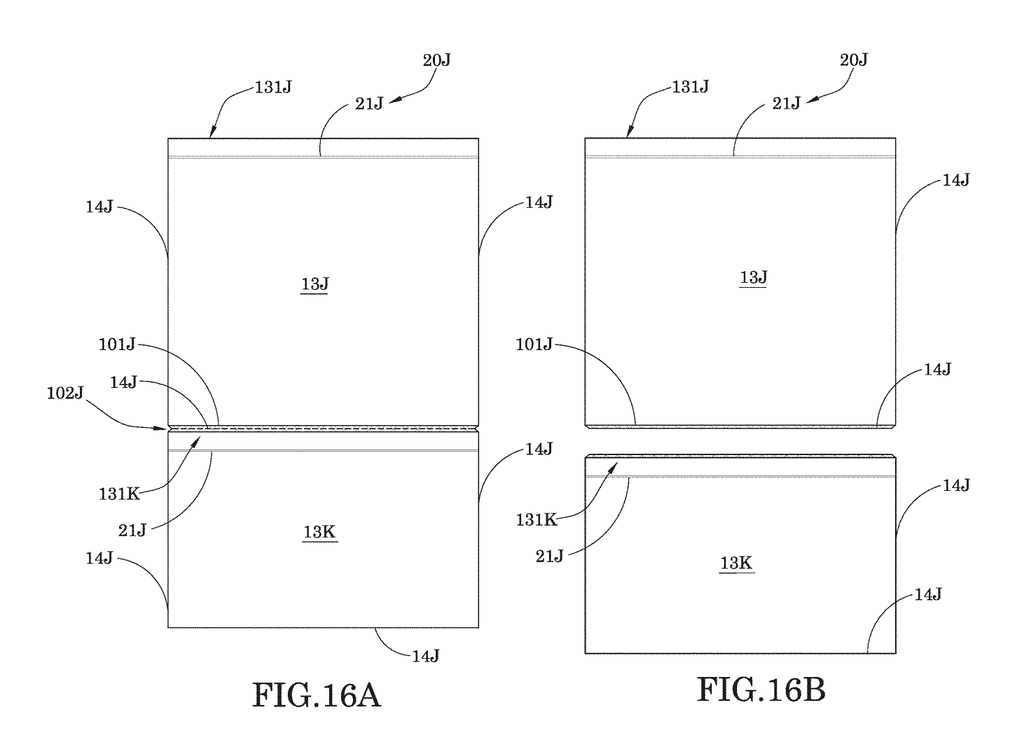

FIGS. 16A and 16B illustrate another alternative mode of the container bag which has the similar configuration in FIGS. 15A and 15B expect the location of the elongated opening 131K of the second sealing pocket 13K. Accordingly, the elongated opening 131J of the first sealing pocket 13J is formed along one side of the bag body 10J, wherein the elongated opening 131K of the second sealing pocket 13K is formed between the elongated opening 131J of the first sealing pocket 13J and the opposed side of the bag body 10J. In particular, the elongated opening 131J of the first sealing pocket 13J is parallel to the elongated opening 131K of the second sealing pocket 13K.

The tearing line 101J is formed along one of the sealing portions 14J of the bag body 10J, wherein the tearing line 101J is located between and is parallel to the elongated opening 131J of the first sealing pocket 13J and the elongated opening 131K of the second sealing pocket 13K. In particular, the tearing line 101J is located above the elongated opening 131K of the second sealing pocket 13K. In other words, the elongated opening 131K of the second sealing pocket 13K is located between the tearing line 101J and the opposed side of the bag body 10J. In order to open the second sealing pocket 13K via the corresponding zip locker 21J, the second sealing pocket 13K must be detached from the first sealing pocket 13J. In other words, the user is able to break the corresponding sealing portion 14J after the second sealing pocket 13K must be detached from the first sealing pocket 13J, so as to open up the second sealing pocket 13K.

The skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A container bag, comprising:
a bag body which comprises a first layer and a second layer overlapped with each other, wherein said bag body further has a plurality of sealing portions provided thereat to form at least a first sealing pocket and a second sealing pocket discretely provided between said first layer and said second layer of said bag body, wherein three of said sealing portions are provided at three sealing edges of said first sealing pocket and three of said sealing portions are provided at three sealing edges of said second sealing pocket, such that each of said first sealing pocket and said second sealing pocket has an unsealed edge serving as an elongated opening; and
a resealable lock comprising a plurality of zip lockers provided at said elongated openings of said first sealing pocket and said second sealing pocket, wherein each of said first sealing pocket and said second sealing pocket is reclosably sealed by said resealable lock.

2. The container bag, as recited in claim 1, further comprising at least a tearing line between said first sealing pocket and said second sealing pocket to allow said first sealing pocket and said second sealing pocket to be torn off along said tearing line, wherein said tearing line is formed along one of said sealing portions of said bag body.

3. The container bag, as recited in claim 2, wherein said bag body further comprises a tearing notch formed at one end of said tearing line.

4. The container bag, as recited in claim 2, wherein said elongated openings of said first sealing pocket and said second sealing pocket at two opposite sides of said bag body, such that said tearing line is formed at said bag body parallel to said elongated openings of said first sealing pocket and said second sealing pocket.

5. The container bag, as recited in claim 2, wherein said elongated openings of said first sealing pocket and said second sealing pocket at the same side of said bag body, wherein said zip lockers are extended end-to-end and are independent actuated to seal and enclose said first and second sealing pockets respectively, such that said tearing line is formed at said bag body perpendicular to said elongated openings of said first sealing pocket and said second sealing pocket.

6. The container bag, as recited in claim 2, wherein said first sealing pocket has the same size of said second sealing pocket.

7. The container bag, as reeded in claim 2, wherein a size of said first sealing pocket is larger than a size of said second sealing pocket.
